(19) United States
(12) Patent Application Publication
(10) Pub. No.: US 2010/0186912 A1
(43) Pub. Date: Jul. 29, 2010

(54) PULP PRODUCTION

(75) Inventors: Jerome Paul Pascal Mauborgne, Cundinamarca (CO); Alex Rossano Imbimbo, Riyadh (SA); Jerome Finbarr O'Donovan, Cheam, Surrey (GB); Jairo Torres, Pereira, Risaralda (CO)

Correspondence Address: JUAN J. LIZARRAGA, 909 POYDRAS STREET, SUITE 2300, NEW ORLEANS, LA, 70112-1010, US

(73) Assignee: ECOPULPA LIMITADA, Cundinamarca (CO)

(21) Appl. No.: 12/308,312

(22) PCT Filed: Jun. 12, 2007
(86) PCT No.: PCT/GB2007/002150

§ 371 Date: Mar. 30, 2010

(30) Foreign Application Priority Data
Jun. 13, 2006 (GB) 0611682.6

(51) Int. Cl. D21C 3/00; D21H 11/00; C07G 1/00

(52) U.S. Cl. 162/90; 162/1; 162/100; 530/500

(57) ABSTRACT

A process for the production of a paper pulp, comprising preparing the pulp from a raw material derived from a plant of the Araceae family.

The present invention relates to the field of the production of pulp, particularly for producing paper and related products, including the production of paper pulp, lignin, paper and agglomerate/composite board materials.

Approximately 95-97% of the raw materials used in the manufacture of cellulose pulp for paper comprise wood derived from conifer and broad leaved tree species. For example, a major source of raw materials for paper production is pine wood from plantations in northern Europe and America. However, the effects of deforestation and the slow growth rates of such species mean that the adverse environmental impact of paper production from tree wood sources is high. In the case of pine wood, there is typically a 30 year cycle required to allow sufficient regrowth before harvesting can be repeated.

The slow growth rates of woody tree species also means that in areas where natural forest resources are scarce, tree planting is typically not an economically viable option to provide paper-making raw materials. The time delay required before trees are ready for felling and the consequent investment involved mean that if paper products are to be produced locally, paper pulp needs to be imported or other sources of raw materials for paper production need to be found. Furthermore, certain species of tree typically used for paper production may not be suitable for growth in particular geographical locations. Local paper pulp and paper production is also in many cases desirable from both environmental and economic points of view, as it avoids the need for energy-consuming transport of raw materials, paper pulp and/or paper pulp over large distances.

There is therefore a need for alternative sources of raw materials for use in paper production, in particular using “non-wood” sources. Any non-woody plant raw material is included under the generic term of “non-wood”. The advantage of non-wood raw materials may lie in the fact that they are readily available as a natural resource in specific geographical areas, they may grow more rapidly than woody tree species, they may have a lower environmental impact than wood-based sources, they may be harvested more economically, and/or that they have specific properties which make them particularly suited to paper-making.

The present invention aims to overcome one or more of the problems discussed above.

Accordingly, the present invention provides a process for the production of paper pulp, comprising preparing the pulp from a raw material derived from a plant of the Araceae family.

In a further aspect, the present invention provides a paper pulp obtainable by a process as defined above.

In a further aspect, the present invention provides a process for the production of paper, comprising preparing a paper pulp as described above, and producing paper from the paper pulp.

In a further aspect, the present invention provides a paper product obtainable by a method as defined above.

In a further aspect, the present invention provides a process for the production of lignin, comprising preparing the lignin from a raw material derived from a plant of the Araceae family.

In a further aspect, the present invention provides a process for the production of a fibreboard material, comprising preparing the boards from a raw material derived from a plant of the Araceae family or from a paper pulp produced by a method as described above.

In a further aspect, the present invention provides a paper pulp comprising an aqueous suspension of plant fibres, wherein the fibres have a mean length of 1.5 to 2.1 mm and a mean diameter of 26 to 36 μm.

In a further aspect, the present invention provides a paper pulp comprising an aqueous suspension of cellulose fibres derived from a plant of the Araceae family.

In a further aspect, the present invention provides a paper product comprising plant fibres having a mean length of 1.5 to 2.1 mm and a mean diameter of 26 to 36 μm.

In a further aspect, the present invention provides a paper product or fibreboard comprising cellulose fibres derived from a plant of the Araceae family.

In a further aspect, the present invention provides an agglomerate/composite board comprising cellulose fibres derived from a plant of the Araceae family.

In a further aspect, the present invention provides use of a plant of the Araceae family for the production of paper pulp, paper products, lignin or agglomerate boards.

By “paper pulp”, it is meant to include any pulp of the kind typically used or suitable for making paper or related products. The pulp used in the present invention is typically a cellulose pulp, meaning that it contains an aqueous dispersion of cellulose fibres derived from a plant of the Araceae family.

The raw material used in the production of the paper pulp may be any part of the plant, including but not limited to stalk or stem, branches, roots or leaves or any mixture thereof, provided that it contains cellulose fibrous material. Preferably the entire plant is used or only the main stem or stalk.

The plant is preferably from the Aroideae sub-family, more preferably from the Montrichardieae tribe, more preferably the Montrichardia genus, and is most preferably a plant of the species Montrichardia arborescens, commonly known as Arracacho, mocou mocou, or moko moko.

The pulping process of the present invention is not particularly limited. Any one of a number of known techniques may be used, including but not limited to a Kraft process, a (caustic) soda process, an alkaline pulp process optionally using an anthraquinone catalyst, a granit wet oxidation process (with or without lignin recovery), a milox process (with formic acid and hydrogen peroxide), a chempolis process, an alcell process, or a NaCO process.

Preferably the process is a soda process using sodium hydroxide. The concentration of NaOH (% by weight of the total weight of the alkaline solution added to raw material) is preferably 10 to 15%, more preferably 11 to 13.5%.

The maximum temperature used in the pulping process, e.g. in the step of contacting the plant fibrous material with NaOH, is preferably 150 to 200° C., more preferably 160 to 170° C., most preferably about 165° C. The pulp is preferably maintained at this temperature for 5 to 60 minutes, more preferably 10 to 30 minutes, most preferably 12 to 25 minutes.

Preferably a water modulus value (a parameter representing the liquor to wood/plant material ratio) of 6 to 8 is used in the pulping process.

Preferably a total yield of 50 to 80%, more preferably 60 to 70% is obtained in the pulping process.

Preferably the pulp has a kappa number (e.g. for bleached and unbleached pulps) of 15 to 80, more preferably 10 to 60, most preferably 15 to 30.

Preferably the pulp has a Canadian Standard Freeness (CSF) value (e.g. for virgin pulps leaving a digestor in the process without any refining) of 200 to 800 ml, more preferably 600 to 800 ml, most preferably 650 to 750 ml.

The cellulose or paper pulp of the present invention preferably comprises fibres having a mean length of 1.7 to 1.9 mm, more preferably about 1.8 mm.

The mean diameter of the fibres is preferably 29 to 33 μm, more preferably 30 to 32 μm, most preferably about 31 μm.

Preferably the fibres have a mean wall thickness of 5.3 to 7.3 mm, more preferably 5.8 to 6.8 mm, more preferably 6.1 to 6.5 mm, most preferably about 6.3 mm.

In a preferred embodiment of the present invention, the pulp is produced with recovery of lignin. This means that lignin is extracted totally or partially from the effluent (black liquor). If lignin is partially extracted, this leaves the option of burning the remaining effluent to produce energy for driving the process or production site, and the lignin can be kept for use in other products. In alternative embodiments, lignin may not be removed but burned with the black liquor.

In a further preferred embodiment, the lignin is used for the manufacture of a fibreboard material. By “fibreboard” it is meant any type of board comprising plant fibres such as cellulose fibres or cellulose/lignin fibres, especially hardboards, for instance agglomerate or composite boards such as MDF (medium density fibreboard). The fibreboard material may be produced in many different shapes or forms, for instance as sheets or panels.

The present invention provides a further alternative source of raw material such as cellulose fibres and lignin for producing paper pulp, fiber agglomerated products and paper-related products. The inventors have surprisingly demonstrated that plants of the Araceae family, and especially Montrichardia arborescens, are highly suitable for producing paper pulp and fiber-related products. These plants therefore provide an attractive non-wood resource for industrial use, which is available in many geographical areas where the harvesting of woody trees for paper production is not feasible due to their scarcity, slow growth rates, or environmental concerns. Moreover, paper pulp produced using plants of the Araceae family as raw material shows desirable properties which may make it superior to pulp produced from a number of other non-wood species.

The invention will now be described in more detail and by way of example only with reference to the following specific embodiments.

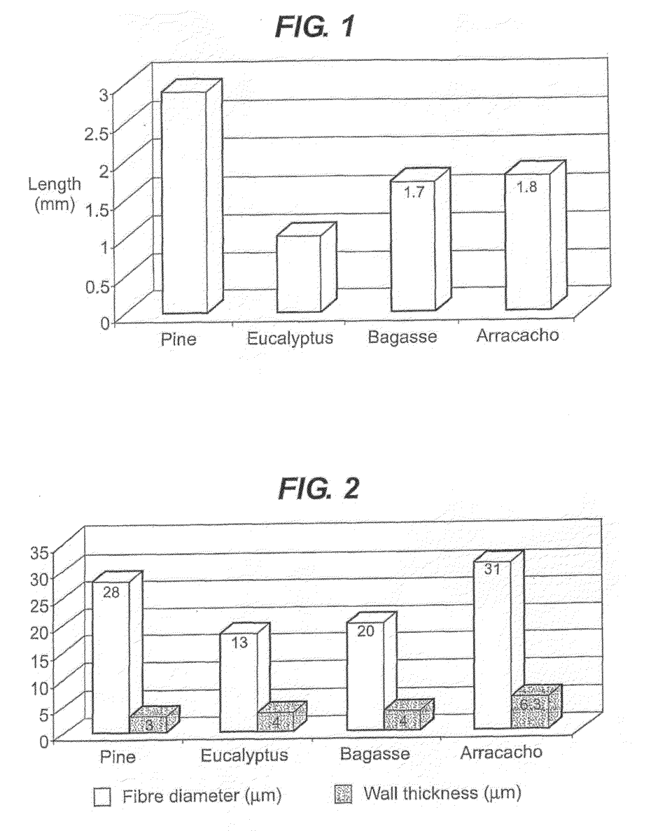

FIG. 1 shows a comparison between the fibre lengths of various species used in the paper industry and Arracacho fibres;

FIG. 2 shows a comparison of fibre diameter and wall thickness for various species used in the paper industry and Arracacho fibres;

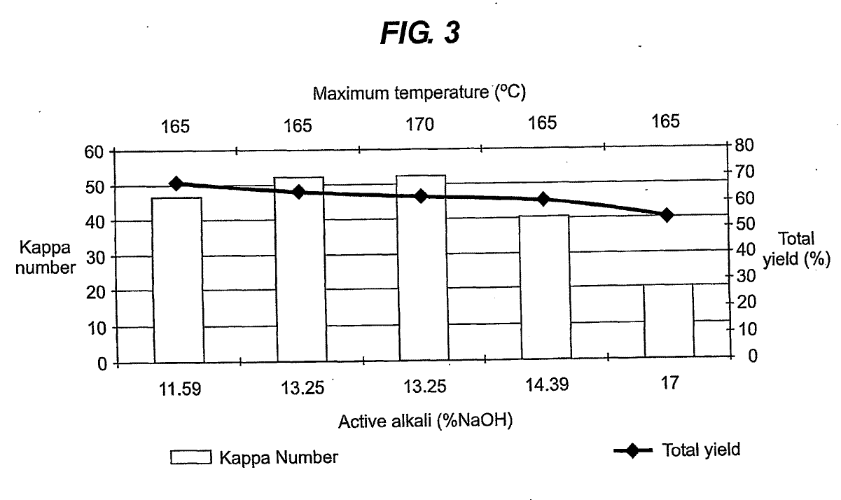

FIG. 3 shows the response of the Arracacho species to different concentrations of active alkali (% NaOH) and different maximum temperatures (° C.);

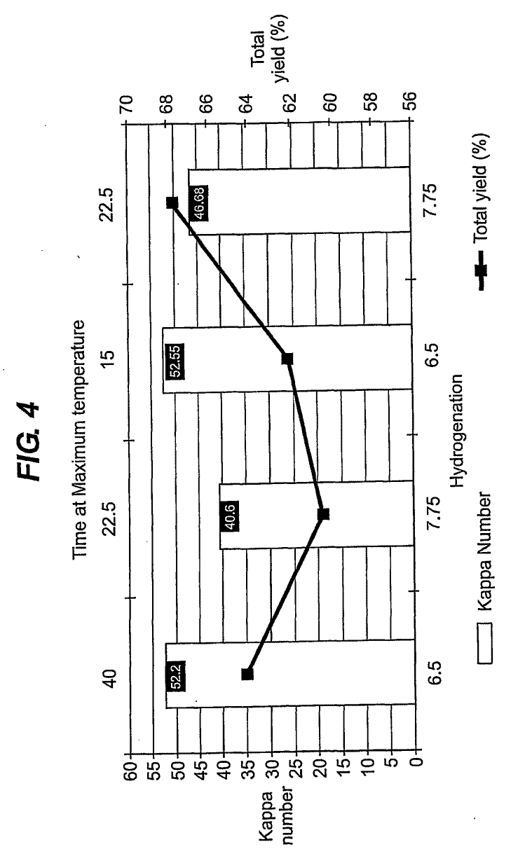

FIG. 4 shows the response of the Arracacho species to different levels of water modulus values and time at maximum temperature;

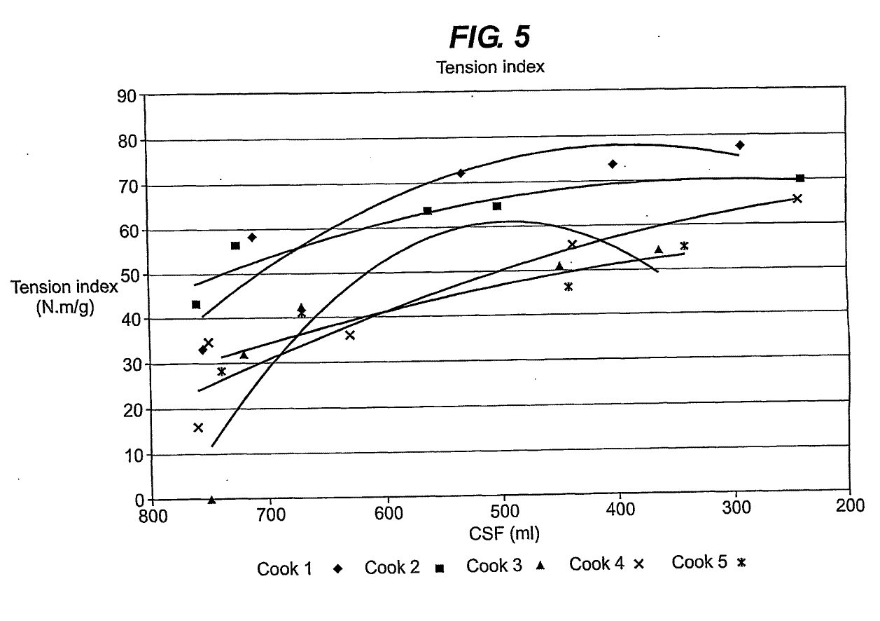

FIG. 5 shows the tension index of various pulps produced according to the present invention;

FIG. 5 shows the tension index of various pulps produced according to the present invention;

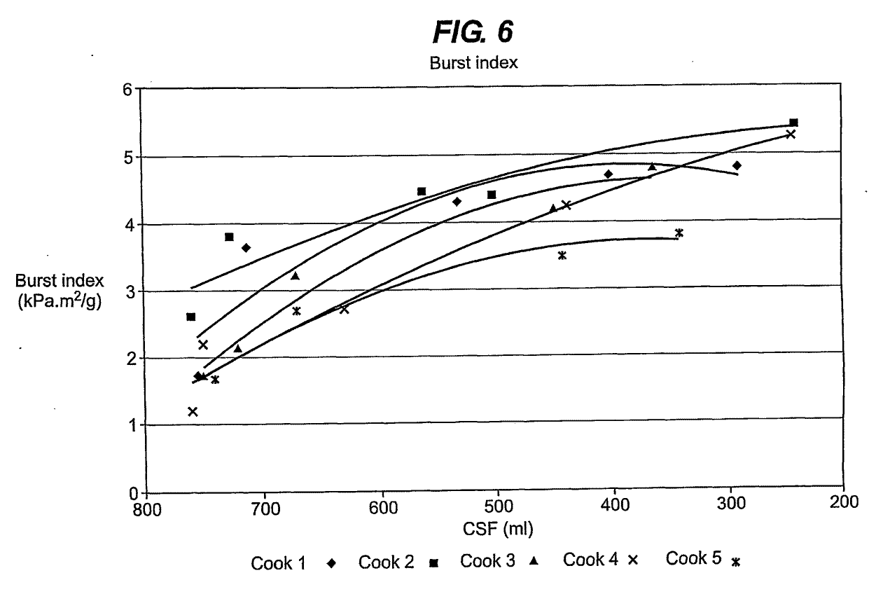

FIG. 6 shows the burst index of various pulps produced according to the present invention;

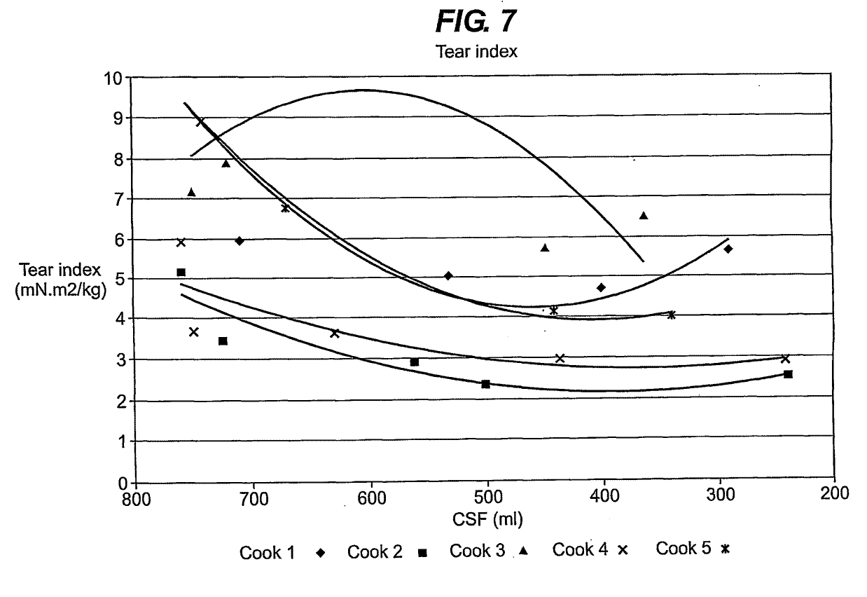

FIG. 7 shows the tear index of various pulps produced according to the present invention;

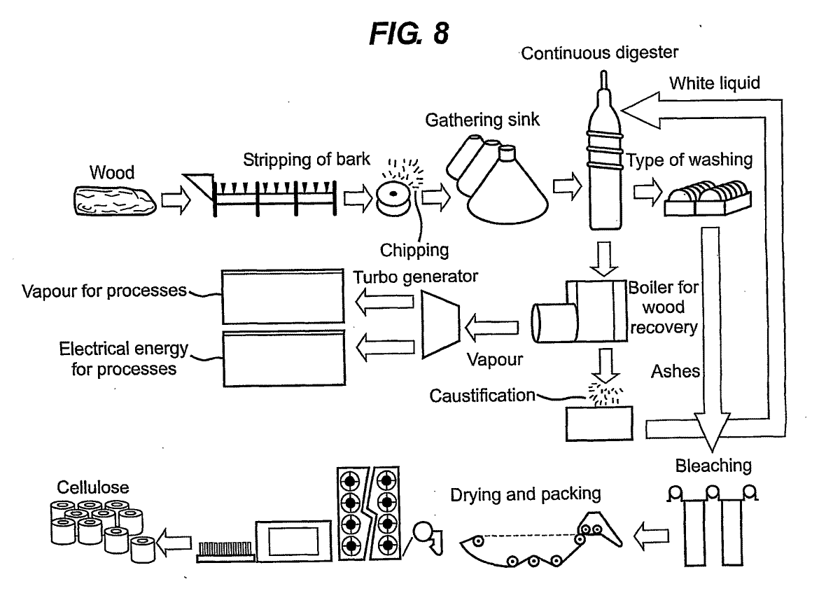

FIG. 8 shows various features of the Kraft alkali pulping process;

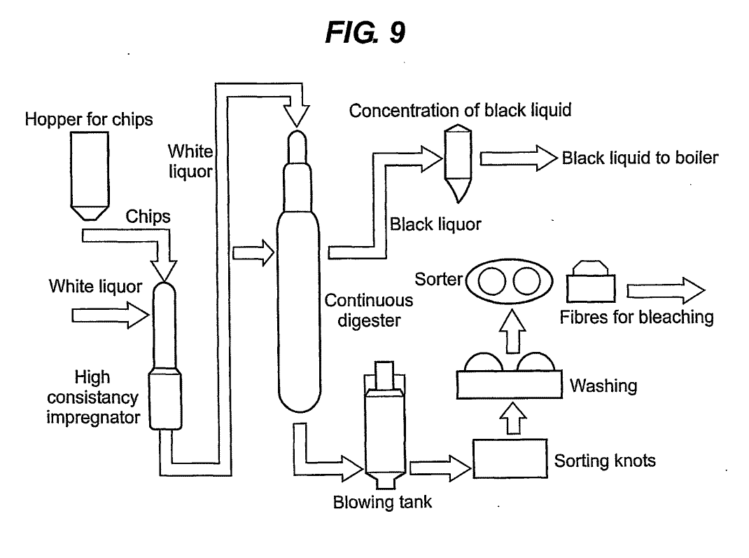

FIG. 9 shows details of the cooking process used in the Kraft process;

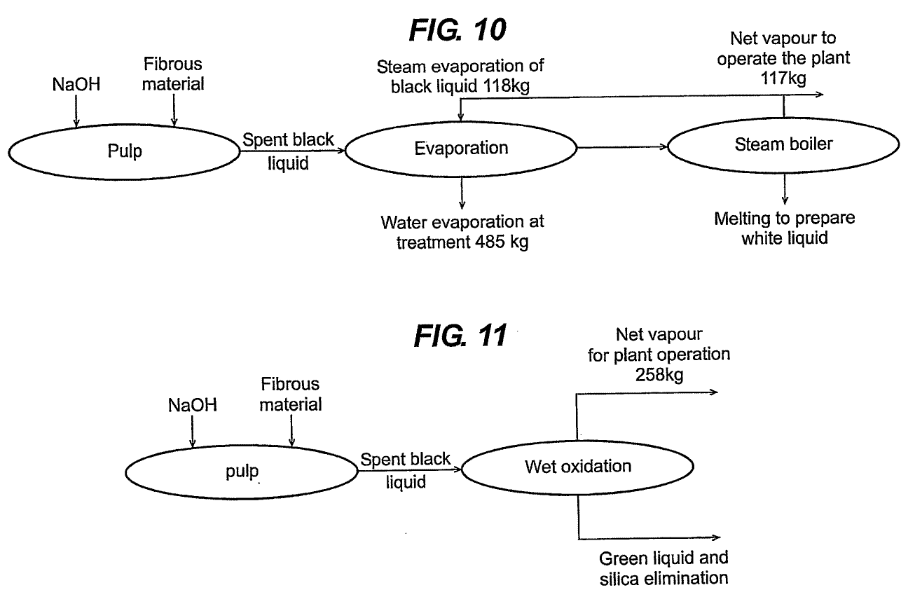

FIG. 10 shows a conventional caustic soda pulping process for bagasse or similar fibrous material, involving digestion, effluent treatment, recovery of chemicals and steam generation;

FIG. 11 shows NaOH pulp production using bagasse or similar fibrous material and effluent treatment by a Granit wet oxidation process without recovery of lignin;

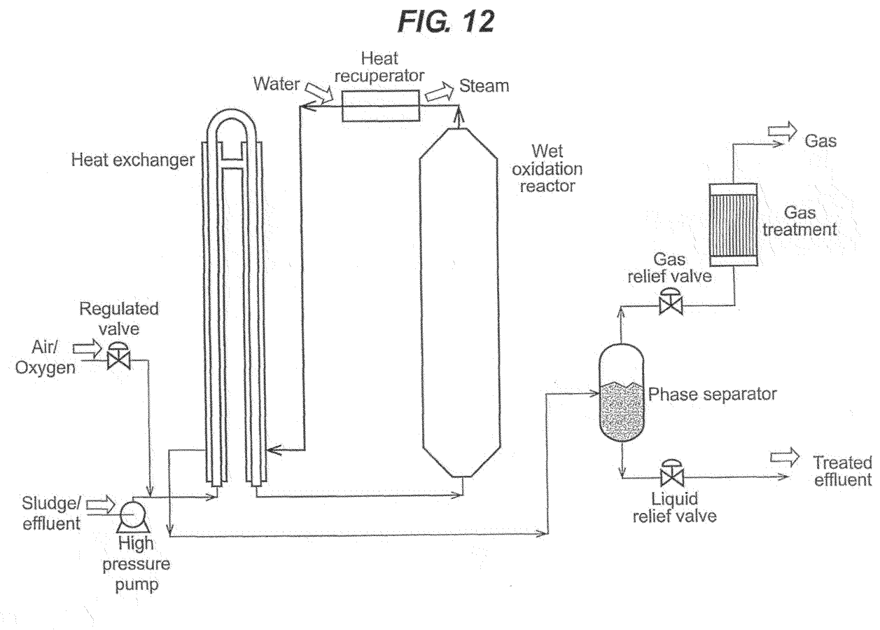

FIG. 12 shows basic effluent treatment by a Granit wet oxidation process;

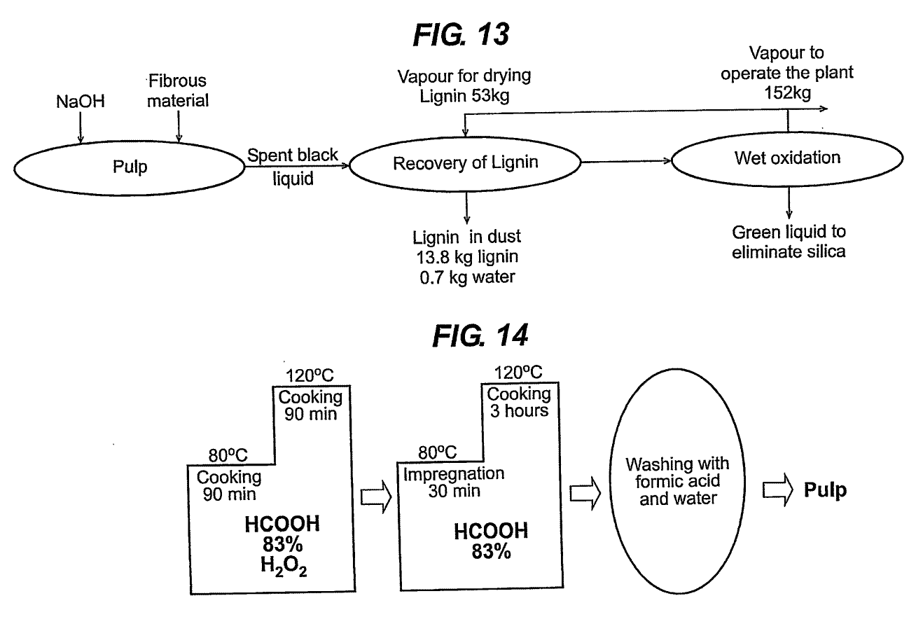

FIG. 13 shows bagasse or similar fibre material pulp production, followed by a Granit process with recovery of lignin and wet oxidation;

FIG. 14 shows a first embodiment of a milox process with cooking-impregnation and washing;

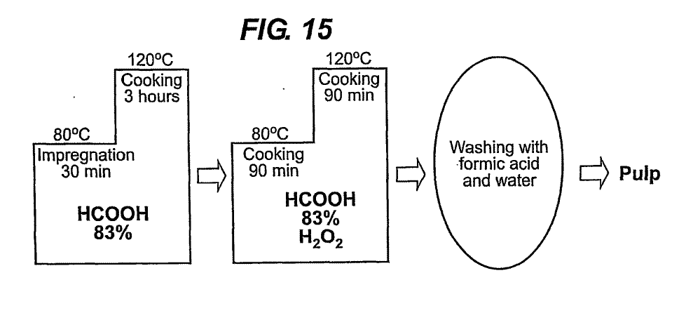

FIG. 15 shows a second embodiment of a milox process with impregnation-cooking and washing;

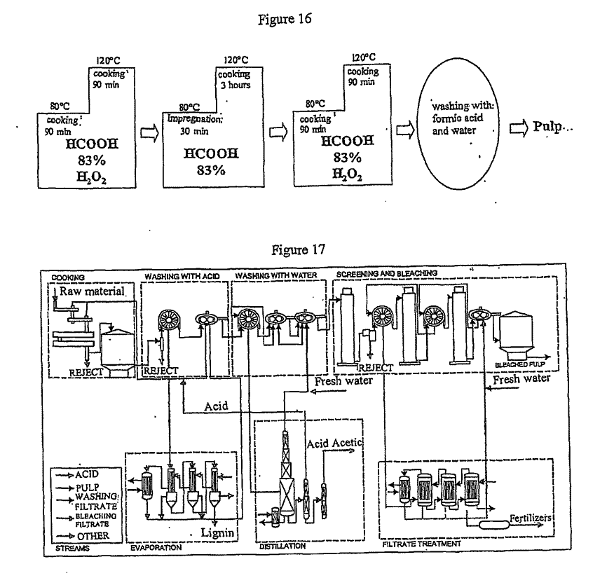

FIG. 16 shows a third embodiment of a milox process with cooking-impregnation-cooking and washing;

FIG. 17 shows a flow diagram of a Chempolis process, a variation of the milox process;

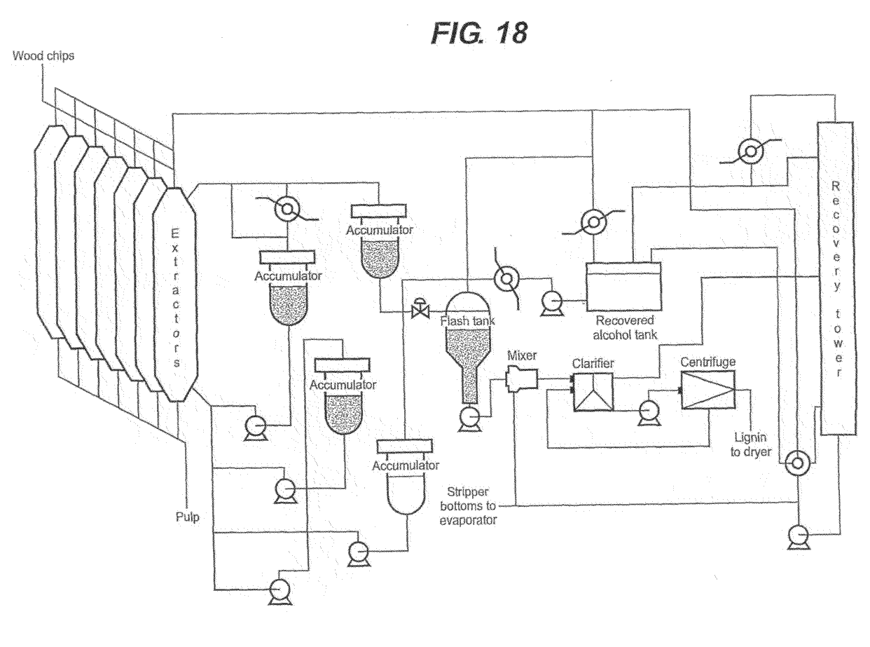

FIG. 18 shows an Alcell process using alcohol as the cooking agent.

Plants of the Araceae family are widely distributed in the tropics; and are often cultivated as an ornamental plant and as a food source (Mayo, S. J., Bogner, S. & Boyce, P. C. 1997, The Genera of Araceae, Royal Botanic Gardens, Kew). When present, they are typically found in a large number of individual plants, which are often of climbing habit and have large leaves. Wherever there is woodland the Araceae are represented, but they are not frequent in the cloudy forest, on the sides of the coastal and Andean mountains and also in the rainforests of the lowlands. Some species however also occur in semi-deciduous woodland and in open areas with a marked dry season (Bunting, G. 1973, Synopsis of the Araceae in Venezuela, Agricultural Botany Institute, Faculty of Agriculture, Central University of Venezuela).

The Araceae have a predominantly climbing habit, climbing up the trunks of trees or rocky walls through adventitious air roots. However many species are erect and terrestrial or marsh-growing, others are truly epiphytic, and some are aquatic, but the climbers and the large erect species are those whose presence is most conspicuous. All are perennial and most are evergreen, although some are deciduous, the latter commonly having a corm which remains latent during the dry season, and at least one species is a deciduous climber. The evergreen species are drought-resistant, and this is probably helped by their succulent nature. Araceae normally grow on sites where there is partial or total shade, but some tolerate full sun (Bunting, 1973).

According to the present invention, the Aroideae are a preferred sub-family of plants within the Araceae family. More preferred are the Montrichardieae tribe and especially the Montrichardia genus. A most preferred member of the Araceae family is MOntrichardia arborescens, commonly known as Arracacho, mocou mocou, or moko moko. M. arborescens has been reported in all countries from Guatemala to Panama, and in Puerto Rico and in the lesser Antilles, Guyana, Dutch Guyana, French Guyana, Venezuela and Northern Brazil (Bunting, 1973).

M. arborescens has an important place in the dynamics of the succession process in many lacustrine and riverine environments, given that once it is established it can influence the establishment of other species in the community through shading out or the build-up of litter. The species can thus be used in plans for the control of erosion and the stabilisation of sediments (Gordon, E. 2002, Taxonomy and ecology of vascular aquatic plants.

Tropical Zoology Institute, Faculty of Sciences, Central University of Venezuela, available at http://www.ucv.ve). Associations or co-associations of Arracacho, M. arborescens, are the most widespread community throughout the alluvial flood plain of the Rio Atrato (Colombian National Natural Parks, 2004). This member of the Araceae is the physically dominant member, forming a very homogeneous continuous layer, and the herbaceous layer frequently contains the species: Blechnum cerolatum, Thelypteris sp, Scleria pterota, S. secans, Panicum sp, Ceratopteris sp and Achrosticum aureum (Zuluaga, 1987 cited by Colombian National Natural Parks, 2004).

This arborescent herb forms colonies in non-stagnant aquatic environments, generally growing on the edges of rivers, streams and swampy areas. The plant reaches a height of 3 meters or more; it has a non-branching stem, which is smooth or rarely spiny and bare, except for a group of leaves close to its apex. The petiole is long and date, the wings ending in a short or long free appendage (up to 7 cm); the distal part without wings is adaxially angular (Bunting, 1973).

The leaf is always simple, from long-oval to triangular in shape and sagittal at the base, with posterior lobes somewhat shorter to somewhat longer than the anterior lobe and sometimes divergent. The proportional width of the anterior lobe varies from half its length to being broader than long; in addition to this its margin varies from concave to convex, and thus the width of the posterior lobes also varies, these sometimes overlapping, whereas in other cases they are separated by a parabolic space. The diameter of the stem and the size of the inflorescence and infrutescence varies in proportion to the size of the leaf (Bunting, 1973).

M. arborescens has unisexual flowers. The flowers bearing pistils are located in the nasal part of the inflorescence, and the flowers bearing stamens are located in the apical area.

The three properties of importance in the use of wood as a raw material for the manufacture of pulp and paper are the length, diameter and wall thickness of the fibres. Fibre length is an important property because of its effect on the strength of the paper, and sheet formation, or uniformity of distribution of the fibre; the shorter the fibres the tighter and more uniform the sheet produced will be.

Fibres of various lengths are used for paper manufacture. Species of the genus Pinus are known in the paper industry as long fibre species having dimensions of between 1.55 and 4.68 mm, with an average length of 2.9 mm. Eucalyptus are known as short fibre species, their lengths varying within the range 0.7-1.4 mm, with an average of 1 mm. However fibres of intermediate length, generally corresponding to non-wood species such as bagasse, which has an average length of 1.7 mm, are also used.

Fibres derived from Arracacho according to the present invention have an average fibre length of around 1.8 mm (see FIG. 1). The value for the length of Arracacho fibres was taken as the average of 750 fibres separated in groups of 4 samples (200, 200, 200 and 150 fibres in each). This fibre length makes Arracacho a raw material perfectly suitable both for providing strength to the paper sheet, with good formation, and is for example excellent for the manufacture of printing and writing paper.

A comparison of the properties of Arracacho fibres with those of other species is shown in the table below and in FIGS. 1 and 2:

| | Range of | Average | Range of | Average | Range of wall | Average wall |
|---|---|---|---|---|---|---|
| | length of | length of | diameter of | diameter of | thickness of | thickness of |
| Species | fibres (mm) | fibres (mm) | fibres (μm) | fibres (μm) | fibres (μm) | fibres (μm) |
| Arracacho | | 1.7-1.8 | | 31 | | 6.5 |
| Bagasse | 0.8-2.8* | 1.7* | 10.2-34.1* | 20* | 1.43-15.6** | 4*** |
| Eucalyptus | 0.7-1.40** | 1.0*** | 11-24.8** | 13*** | 2-8** | 1.6*** |
| Pine | 1.55-4.68** | 2.9*** | 35-45* | 28*** | 2.80-19.6** | 3*** |

*Hamilton, F. & B. Leopold. 1993 - Pulp and paper manufacture. Volume 3, Secondary Fibres and non-wood Pulping, Tappi Press, Atlanta, GA, USA.
**Phillip, P. 1988 - Cellulose and Paper Volume 2 The Technology of Paper Production, Tappi Press, Atlanta, GA, USA.
***Sanjuan R.1997 - Obtaining pulps and properties of their fibres for paper, University of Guadalajara, Mexico.
*Smook, G. 1990 - Technical Manual for pulp and paper, Tappi Press, Atlanta, GA, USA.

Fibre wall thickness and diameter are other important characteristics affecting the strength and workability of the raw material. In paper manufacture fibres of larger diameter with thin walls are superior to slender fibres with thick walls. This is related to their flexibility and ability to collapse.

FIG. 2 shows a comparison of the fibre wall thickness and fibre diameter of fibres most frequently used in the manufacture of paper and Arracacho. It will be seen that Arracacho has a larger diameter and a greater wall thickness than the other species. However, in comparison with bagasse it has the same proportion between fibre diameter and thickness. From the point of view of pulp yield the wall thickness of the Arracacho is not a disadvantage, but fibres having thicker walls are more rigid and tend to maintain their original (tubular) shape, and this does not contribute to linking between fibres. They tend to produce an open, absorbent and bulky sheet with low resistance to bursting and tension, but with high resistance to tearing. Given that in comparison with bagasse they have a similar proportion between diameter and thickness, the wall thickness and diameter of Arracacho fibres make them equally suitable for use in the process of paper manufacture.

The following analysis of the composition of Arracacho, with particular relevance to parameters of interest for the use of the species as a raw material for paper production, was also carried out:

| | Value as % |
|---|---|
| Valuation References | by weight |
| 1. Percentage of moisture in the sample | 10.41 |
| 2. Percentage of ash in extractables* | 02.88 |
| 3. Percentage of extractables** | 19.82 |
| *Alcohol - benzene + ashes | 01.76 |
| *Alcohol at 97% + ashes | 09.04 |
| *Hot water + ashes | 11.90 |
| 4. Percentage of ashes in free extractables | 01.07 |
| 5. Percentage of lignin in total material | 17.46 |
| 6. Percentage of cellulose in total material | 34.10 |
| 7. Percentage of hemicelluloses in total material | 24.67 |

*This (2.88) is the % of ashes found in the extractables and is the result of subtracting from the total (4.26%) of ashes the value of this factor (1.38%) found in the free extractables
**This value is obtained by subtracting the total of extractables less the ashes (2.88%)

Preliminary studies, using the (caustic) soda process, where pulping conditions have varied, have produced very promising results, including a very high yield, producing values between 55% and 60% which are better than those obtainable by chemical pulping of wood (45-55%).

In order to evaluate the pulpability of M. arborescens (Arracacho), the following process was carried out. 60 kilograms (wet weight) of Arracacho plants were harvested. This material was then subjected to grinding as the first stage in shredding to produce 34 kg of ground material which proceeded to the next stage. The difference is mass between the starting material and the ground material is due to water which is lost at this stage.

In the next stage of the procedure, the ground material was treated by dry and wet depithing to leave 4.2 kg pulped material with a moisture content of 10%, i.e. 3.8 kg dry weight. The mass lost at this stage is due to the eliminated pith.

5 preliminary cooks were then performed during which conditions were varied. A soda process was used in order to treat the pulp in each cook.

Pulping conditions for the Arracacho species (Montrichardia arborescens)

| | | | Water | Time at |
|---|---|---|---|---|
| | | Maximum | modulus | maximum |
| | Active alkali | temperature | (liquour to | temperature |
| | (% NaOH) | (° C.) | wood ratio) | (minutes) |
| Cook 1 | 13.25 | 165 | 6.5 | 40 |
| Cook 2 | 14.39 | 165 | 7.75 | 22.5 |
| Cook 3 | 13.25 | 170 | 6.5 | 30 |
| Cook 4 | 11.59 | 165 | 7.75 | 22.5 |
| Cook 5 | 17 | 165 | 6.5 | 60 |

The results indicate the suitability of Arracacho as a raw material for making paper pulp. In particular, a high yield, i.e. 50-70% was obtained. This refers to total yield and not purified yield. A pulp free from uncooked material was obtained in Cook 5, and in this case it can be said that the total yield is the same as the purified yield.

The yield of pulp from Arracacho compares favourably with the yields obtained during the chemical pulping of wood (45-55%). Thus in one embodiment of the process above 2.014 kilograms of pulp were obtained from 3.8 kilograms of shredded Arracacho (dry weight). On this basis it can be concluded that approximately 3.4 kilograms of brown pulp can be obtained from every 100 kilos of Arracacho extracted from its place of origin.

Various properties of the obtained pulps were studied, which are discussed below.

Kappa number is the number of milliliters of 0.02M potassium permanganate solution consumed by 1 g of dry pulp in 10 min during treatment with potassium permanganate in sulphuric acid solution. The result is converted to correspond with consumption of 50% permanganate. The method applies to all chemical pulps within the kappa number range from 5 to 100. It is important to realize that there is no general and unambiguous relationship between kappa number and lignin content of the pulp. This relation varies according to wood species and delignification procedure. All compounds oxidized by permanganate (not only lignin) will increase the consumption of permanganate and increase the kappa number.

Tensile strength is a very useful property to describe the general strength of any material. For paper, it is the maximum force per unit width that a paper strip can resist before breaking when applying the load in a direction parallel to the length of the strip. In the tensile strength tester, the test piece is stretched to the point where rupture occurs. The maximum tensile force the test piece can withstand before it breaks and the corresponding elongation of the strip are measured and recorded. Tensile strength is expressed in units of kN/m.

From the tensile strength measured, calculation of the tensile index uses the following formula:

Tensile index=Tensile strength/Basis weight

The units for tensile index are Nm/g.

The tensile index value relates strength to the amount of material being loaded. Tensile index therefore has primary use to describe the strength of pulps. Characterization of papers usually uses the tensile strength value as such. The reason is that paper is an end product for which tensile strength is an important characteristic.

Tensile strength of a paper depends on fiber strength but primarily on the degree of bonding between fibers. It therefore has frequent use in pulp testing as a general characteristic for the capability of bonding between fibers. The result obtained also depends on the testing conditions. An increase in the rate of loading will increase the tensile strength. An increase in moisture content of the paper will decrease the tensile strength while increasing elongation.

The tensile strength is highly dependant on directionality of the paper. The tensile strength measured in different directions of the sheet is often used as an indicator of fiber orientation.

Bursting strength is the maximum pressure that the paper can resist without breaking with pressure applied perpendicular to the plane of the test piece. The unit for bursting strength is kilopascal, kPa. Calculation of the material related burst index uses the following formula:

Burst index=Bursting strength/Basis weight

The most common tester used for bursting strength measurements is the Mullen tester. A test piece placed over a circular elastic diaphragm is rigidly clamped at the periphery but free to bulge with the diaphragm. The hydraulic fluid pressure increases by pumping at a constant rate to bulge the diaphragm until the test piece ruptures. The bursting strength of the test piece is the maximum value of the applied hydraulic pressure. The tester itself and especially the pressure measuring manometers are sensitive to errors that often make the results unreliable. In modern testers, these manometers have been replaced by electronic pressure transducers that are much more reliable.

The internal tearing resistance or tearing strength is the mean force required to continue the tearing of paper from an initial cut in a single sheet, ISO 1974, or a pad of sheets. If this cut is in the machine direction, the result is machine direction tearing resistance. Correspondingly, the cross direction tearing resistance is the result of a test in the cross direction. The tearing strength is highly dependent on the fiber orientation of the sheet. The unit for tearing strength is newton (N) or millinewton (mN).

From tearing strength, calculation of the tear index uses the following formula:

Tear index=Tearing strength/Basis weight

Tear index units are mN×m2/g.

Characterization of pulp slurries often involves measuring the drainage resistance. The most common methods are the Canadian Standard freeness (CSF) and Schopper-Riegler (SR). Both methods are a relative measure of the drainability of a pulp suspension.

CSF measurement involves filtering 1 L of diluted pulp suspension with a consistency of 3 g/L freely through the screen plate of the testing device. Faster slowing of draining due to fiber mat accumulation on the screen plate gives a smaller CSF number. CSF is the amount of water passing through the side orifice of the tester. The measurement principle of SR number is the same as CSF. In SR testing, 1 L of pulp suspension with a consistency of 2 g/L filters through the wire of the apparatus. More rapid slowing of drainage gives a higher SR number. This means that SR number is directly proportional to the drainage resistance of the stock and CSF number is inversely proportional.

Various Kappa numbers were obtained in the cooks performed (see FIGS. 3 and 4), one of these having a value of 20.34. With these properties the pulp obtained can easily be subjected to a bleaching process, whether Elementary Chlorine Free (ECF) or Totally Chlorine Free (TCF), producing pulps with a high degree of whiteness, ideal for the manufacture of printing and writing papers.

Because of the morphological characteristics of the Arracacho species (a relatively large wall thickness), a relatively large amount of alkali and a relatively long cooking time are required in comparison with other non-wood species like bagasse. This is required in order to allow a sufficient impregnation by the liquors during cooking.

The strength of the pulp is illustrated in FIGS. 5, 6 and 7, showing tension index, burst index or tear index plotted against CSF values for each cook. For each cook prepared using specific conditions in the soda process, a virgin pulp is first obtained. The virgin pulps typically show a CSF value of 600 to 800 ml, e.g. 650 to 750 ml. Each virgin pulp was then further refined, which leads to a decrease in the CSF value. At various stages of the refinement process, each stage having a characteristic CSF value, the tear index, burst index and tension index was tested for each cook, and the results plotted in FIGS. 5 to 7.

Making a comparison between different cooks, it will be seen that those pulps which were produced under less drastic conditions have greater mechanical strength, and this may be due to lesser degradation of the cellulose. These results demonstrate that it is possible to obtain a pulp of higher resistance as compared with kraft pulps derived from conifers.

The above results demonstrate the suitability of Arracacho as a raw material for the manufacture of printing and writing paper, because of its length of fibre, intermediate between conifer and broadleaf, which imparts both strength and excellent paper-forming properties. Despite the fact that the wall thickness is greater than that of bagasse and conifers, it offers good mechanical strength and rigidity which makes it suitable for the manufacture of corrugated paper after mixing with long fibre or by itself, which would be possible using pulps with a high kappa number (over 50%). Its other properties also confirm that it is a very versatile fibre, which when adequately mixed with different types of fibre could have other uses.

According to the present invention, any suitable method may be used to produce a pulp comprising cellulose from a plant of the Araceae family, especially M. arborescens. The method typically involves the removal or separation of lignin from the cellulose-containing pulp. According to preferred embodiments of the invention, the process involves the recovery of the lignin which is separated from the pulp, such that the lignin may be used for further applications, such as an agglomerating agent for the production of boards and for the production of lignosulphonates to be used in the perforation of oil wells.

The separation of lignin is an important step in many processes for the manufacture of cellulose pulps, which are used later for the production of paper or its derivatives. Whitening is often a further important requirement of such methods, and may also be used in the present invention. The nature of the steps, including isolation and purification, included in the process may vary according to the type of cellulose that is ultimately desired to obtain, for example the degree of polymerization (DP) which is required, and the level of ash, lignin-containing cellulose (many pulps still contain a small amount of residual lignin after the digestions and bleaching processes), or residual hemicellulose (which can add bulk to the pulp improving the yield) which is sought in the pulp.

De-lignification may be performed through the sublimation of lignin and separation of the fibres. Although this can be achieved with good yield by the use of organics solvents, such a process is not typically practical on a large commercial scale. Hence commercial de-lignification is typically based on procedures that render the lignin soluble in water. Due to the fact that lignin in free form normally has a low solubility in water, these de-lignification processes typically use acids or alkalis which increase the solubility of the lignin. Such de-lignification steps may be used in embodiments of the present invention.

The pulping process or production of a suspension of cellulose fibres in water according to embodiments of the present invention may optionally entail one or more of the following steps:
Preparation of the raw material: these are operations such as washing, cutting, chipping, and cleaning of the plant, e.g. the trunk, stalk or stem; these steps may facilitate later treatments.
Production of the paste or pulp: this may be done in various ways (chemical, mechanical and chemical-mechanical methods) according to particular species from which the raw material is derived and the quality of the pulp it is desired to obtain. Sub-products may be obtained in this step, such as lignin, furfural and others which, depending on the grade of purity and treatment, can be of value equivalent of superior to that of the pulp.
Washing: done to eliminate dissolved substances in the paste.
Purification and cleaning: the fibres are treated to leave them free from foreign substances.

The cellulose pulp obtained by the processes of the present invention may be used to make paper or other related products according to known techniques, optionally on a large scale using sophisticated machinery. In certain embodiments, the pulp may be mixed with a pulp derived from other species or sources (e.g. from another non-wood or a wood-based source), according to the nature of the paper product (e.g. the quality of the paper, its strength or smoothness) which is desired.

According to specific embodiments of the present invention, the pulping process which is used may be one or more of the following processes.

### 1. Kraft Process

This alkaline process is the most common way of producing pulp from woods. It typically produces a high quality pulp, because the sulphurated materials used allow a greater penetration into the raw materials. The high costs and investment in machinery, especially for the boiler, are compensated by the production of energy and the recovery of the reagents used. It can also be used for non-wood materials such as according to the present invention.

According to this process (see FIGS. 8 and 9), the plant raw material is decorticated, chipped, and sent to a chip store for homogenisation. From the store pile, the chips are extracted, classified and taken to the boiling process—in the continuous digestor—with white liquid, an alkaline solution of caustic soda water and sodium sulphate. The sulphites and caustic soda water function to allow extraction of the lignin. These chemical components are recovered later to be used in a closed-cycle process. The cellulose paste remains after the cooking process, which is classified, washed and whitened. Once whitened, it goes on to the final drying.

The white liquid used in the boiling, together with the dissolved lignin, are converted into a black liquid, which is concentrated to be used later in recovery boilers. The organic part of the black liquid (lignin and other components of the plant raw material) produce the energy in the combustion process, generating steam that is used in the production of electrical energy and, later, in different process inside the industrial plant. The inorganic parts, the mineral salts (ashes) are recovered after the combustion process and used in the caustification phase to regenerate the white liquid used in the boiling.

Cuttings of the plant raw material, recovered from the crumblers, may be burnt in power boilers to produce steam and electrical energy, and used in diverse processes around the plant.

Conditioning and refining steps may be used to give the fibres adequate size, thickness and shape for later treatment. A whitening step, which consists of the elimination of residual lignin and of the coloured components of the paste (which remain after the boiling and washing), may also be used. Further possible steps include treatment and/or elimination of effluent resulting from the boiling, including the recovery of the reagents, and production of energy in the form of high- or low-pressure steam.

The kraft process has several advantages
Many types of plant raw material can be used, which provides flexibility in the provision of pulp.
Substantial quantities of chippings can be processed.
There is a short boiling time.
The pulp has excellent resistance.
The recovery process of the black liquid reagents is well established.
Different types of kraft pulp can be produced, whitened or unwhitened. The latter may be used as packing paper because of its resistance.

The following table shows some of the principal characteristics of a Kraft process which may be employed according to the present invention:

| | | | | | Yield |
|---|---|---|---|---|---|
| | | | | | in Pulp |
| | | active | Max temp. | Time | (% by |
| pH | Base | agents | (° C.) | (h) | weight) |
| 13-14 | Na⁺ | HS⁻, HO⁻ | 155-175 | 1-3 | 45-55 |

### 2. Caustic Soda Process

According to the present invention, the crushed non-wood plant material arriving at the boiling process may be in a more crumbly state than is the case with, for example, wood-based raw materials. Accordingly, a soda process may be used in preferred embodiments of the present invention. The crushed plant material used in the present invention typically allows a greater penetration of soda water than for wood-based material. Because it also has a lower content of lignin, sulphate (as used in the Kraft process) may not be required. The soda process has the advantage that is does not produce the pungent odours derived from the sulphate used in the Kraft process.

The soda process is often used to produce pulp from non-wood species and from agricultural residues such as cane, bagasse, wheat straws etc. It may be performed with caustic soda water at 12-15% at a temperature of 160-170° and pressure of 100 psi. A pulp yield of 50% is rendered from this boil. In the case of Arracacho, yields of 53-54% were obtained.

After the boiling, the pulp is washed in crosscurrent in rotating drums where a black liquid is produced, containing approximately 10% solids, principally lignin.

Normally the black liquid remaining after the boiling is passed through a series of evaporators which take the liquid's consistency to 50%. This is then burnt in sophisticated high-temperature, high-pressure boilers, producing steam which is circulated first to the evaporators and later, at lower pressure is used to produce energy for the complete pulping process.

The boiling reagents are recovered from the ashes left over after the incineration of the black liquid, and re-used in the caustification phase to generate the white liquid used in boiling.

A soda process suitable for use in the present invention is shown in FIG. 10.

3. Alkaline Pulp Process Catalysed with Anthraquinone

Anthraquinone (AQ) may be used as a catalyst in alkaline pulping processes in quantities between 0.05 and 2% of the weight of the dry fibrous material with the aim of stabilising the carbohydrates and accelerating the de-lignification, increasing the yield by between 2-3%. Due to its high cost and the fact that it is impossible to recover it (it breaks down during boiling) its use is restricted.

The following objectives can be achieved with the use of AQ:—
Increase in the pulp yield and therefore in output
Reduction in the consumption of fibrous material per tonne of pulp
Energy savings
Reduced demand for other reagents in cooking
Reduced sulphur levels which reduce the emission of smells
Extension of the de-lignification which improves the “whiten-ability” and reduces water contamination.

### 4. Granit Process

Granit Wet Oxidation Process without Recovery of Lignin (see FIG. 11)

The core of the Granit process is the Wet Oxidation Process (WOP, see FIG. 12), which is a continuous process that destroys organic matter. The reaction occurs at high temperatures and high pressure with oxygen and air, and without fuel. This generates heat in the form of steam and the by-products are carbon dioxide, water and eventually a residual mineral.

An effluent, containing an oxygen demand between 20 and 120 g/l of organic substance, can be processed using WOP. The grade of reduction of the organic substances can be regulated between 70% and 99.5%. The energy generated by the reaction has significant advantages over conventional recovery technology because it is much more efficient energy-wise if lignin is recovered, given that without the recovery of lignin more than twice the steam is produced whereas with recovery just 30% more is produced.

The following operating conditions may be used according to embodiments of the present invention:—
Operating temperature 250-320°
Operating pressure 50-130 bar
Reduction of COD of 70% up to 99.5%
   Granit Wet Oxidation Process with Recovery of Lignin

In this process (see FIG. 13) the black liquid obtained in the washing of the pulp is treated with a mineral acid or dioxide to precipitate the lignin. The obtained precipitate is dehydrated and washed in a filtering phase and the cake that remains is dried to produce lignin in the form of a dust that contains 5% humidity. In recovering the lignin nearly 50% of the chemical oxygen demand is removed and it is then possible to try a biological treatment as a valid alternative procedure.

Lignin obtained from the non-wood fibres of the present invention can be used advantageously in many of the applications dominated by lignins and lignosulfates obtained by the Kraft process. Its high purity and the absence of sulphur allow its use in products such as computer tables. Other visualised areas of importance are in polymer mixes, in concrete and other chemical uses in the construction of agglomerate boards. It may also be used as an additive to paper, to optimise the properties of packing materials in wet or humid conditions.

The combination of the Granit processes, of lignin production and of wet oxidation with the conventional pulping process with a recovery system can be set up in smaller recovery boiler/evaporator installations with a corresponding reduction in costs and investment.

### 5. Milox Process

This pulping process uses formic acid and hydrogen peroxide in different combinations and sequences that best suit each raw material, and the desired pulp.

In a two-phase sequence, the dry raw material is first impregnated with formic acid at 83% for a period of 30 minutes at 60-80°, and then boiled for between 45-180 minutes at 100-120°. The spent liquid is then filtered and the fibre is treated with a mixture of formic acid and hydrogen peroxide, first for 90 minutes at 80° and then another 90 minutes at 120°. The pulp is washed with 83% formic acid and then finally with water.

In a first embodiment of this method, a first sequence (AF−AF+P where AF=formic acid and P=hydrogen peroxide) is used, as shown in FIG. 14.

In a second embodiment of this method, a second sequence consists of inverting the two previous stages and adding a third stage of treatment with formic acid between the two treatment stages with the mixture of formic acid and hydrogen peroxide, as shown in FIG. 15.

In a third embodiment, a third sequence (AF+P−AF−AF+P) is used, as shown FIG. 16.

Because this is an acidic process, the silicates present in the fibres don't dissolve in the black liquid. Therefore they can be recovered if a recovery phase is included in the process. The lignin is precipitated with water from the spent liquid, washed and dried. It has the same uses as those mentioned in the granit process. The pulp obtained is highly reactive with alkaline peroxide, which makes it easy to whiten.

The advantages of the Milox process are as follows.
Low temperatures and unpressurised reactors.
Easy whitening
Simple recovery of chemicals.
By-products are free from sulphur
Appropriate for non-wood materials that contain silica, e.g. the plant material used in the present invention.

Under certain circumstances, this method may have disadvantages such as problems with corrosion.

### 6. Chempolis Process

This pulping process (shown in FIG. 17) was developed for fibrous wood materials and non-woods where formic acid is used as a boiling agent or solvent. Boiling is performed at atmospheric pressure or just above, at a temperature between 80 and 95°. Since the boil is in an acid, the silica is not dissolved in the black liquid, thus avoiding the usual problems associated with this in the pulping of non-woods. The chemical recovery is achieved simply—by distilling—which doesn't need any chemical compensation given that the formic acid is generated during the boiling. The process produces bright, resistant pulp superior to that obtained in the Kraft process.

Technical advantages:
a) Specially developed for non-wood raw materials. The high silica content of the non-wood raw material does not impede the chemical recovery, because the de-lignification is centred on the use of formic acid. The acidic de-lignification conditions stop the silica dissolving.
b) Ease of Whitening TCF
   Metallic ions present in the material, such as iron, copper and magnesium, are eradicated during the boil
   Selective boiling improves the reaction between the lignin-hydrogen peroxide, and chlorine-based chemicals are not needed
   Whitening treatment is immediate
   Hydrogen peroxide-based whitening doesn't require equipment on site for the manufacture of whitening agents
c) Easy production of high-quality pulp.
   A selected, effective dissolution of lignin is boiled in a mixture of formic acid and water
   Boiling results in a uniform pulp with low content of shieves (fines)
   Boiling conditions that allow a controlled hydrolysis of hemi-cellulose, which is beneficial when the properties of the pulp products are optimised
d) Pulp manufactured by the Chempolis process has better drainage ability than pulps from conventional methods.
   Better drainage ability results in differences in the properties of the boiling liquid, modification of the composition of the fibre's cell wall and the swelling of the fibres.
   Better efficiency and capacity in the washing stage and in the formation of paper.
e) Favourable conditions for acid recovery
   Direct formic acid recovery from the consumed liquid through basic thermic operations, such as evaporation and distillation.
   Zero increase of silicates in the heat exchange equipment.
   No soluble chemicals present in the evaporation.
   Direct evaporation leaves a high content of dry solids.
   Acetic acid formed during the de-lignification is separated in the distillation phase and is a valuable by-product
   Dissolved lignin is obtained as a dry by-product
   Dry lignin has an energy value as high as 22-23 MJ/Kg
   Lignin can be burnt in conventional boilers because the chemical recovery is independent of the combustion.
   Ash from the boiler can be used as a fertiliser.

Other advantages:
Little machinery is used in the process.
Fast continuous boiling at low temperature
Convenient drainage of the pulp
Ease of whitening
Advantageous chemical recovery
No requirement to treat silica or other composites in the ash
Process is economical on a small scale and allows economical use of local wood and non-wood sources
Operating cost is low owing to the efficiency of the process
High efficiency of the raw material, as long as all the composites of the material are taken advantage of.
Low chemical consumption. The formic acid and acetic acid are produced in the process. Acetic acid is obtained as a by-product, which corresponds in value to the formic acid.
Chemicals and water are re-usable, which saves money on the treatment of water.
g) Environmental Advantages:
   The solution is environmentally friendly due to the use of all waste products of the non-wood raw material.
   Avoiding silica-related problems allows chemical recovery in a completely closed circuit. Concurrently, the majority of the composites that cause an increase in the chemical oxygen demand are recovered as by-products, resulting in a lower burden of COD in the process.
   Formic acid and hydrogen peroxide are biodegradable and environmentally friendly.
   All of the chemical processes are chlorine-free, therefore the pulp does not contain any toxic residues, and the filtered water is biodegradable.
   No stinking, air polluting, sulphurous emissions are produced.
   Low water consumption
   Generates a useful source of bio-energy from lignin.
   Option to use completely closed cycles of water.
   Option to recover the raw material's nutrients, which can then be used as fertiliser.

### 7. Alcell Process

The ALCELL process uses a pulping technology based on a self-catalysing ethanol-based solvent. Its advantages over the Kraft process derive from the fact that the chemical compounds Na₂S and NaOH are not needed. This eliminates the generation of smelly sulphurous compounds and the need to invest in an expensive recovery oven. It also allows much lower levels than the Kraft process demands. Furthermore, whitened pulp produced by the solvents used in this technology is easier to whiten than the pulp obtained in the Kraft method. It is possible to use various whitening sequences which eliminate the need to use chlorine in whitening plants, which in turn leads to a more environmentally-friendly process.

The ALCELL process is illustrated in FIG. 18. It has a team of digesters that recycle the pulp liquid in countercurrent. The pulping cycle starts loading processed vegetable material inside the first digester which works as an extractor at a temperature of some 200°, which generates a steam pressure of up to 400 psi.

The other digesters serve as washers, the final one carrying the pure pulp liquid as a mixture of ethanol/water at 50/50%. This liquid is sent back to the previous digester in a way that means the pulp is being washed again and again in a liquid that contains fewer and fewer solids. In the extractor the liquid coming from the second digester is sprayed around so that the fibre is brought to the cooking temperature very quickly, purging the air inside the container.

Here the first boiling cycle starts, lasting approximately an hour. The liquid from the first container (containing dissolved solids—largely lignin—of low molecular weight, hemi-cellulose, “furfural”, and acetic acid) is moved from the extractor to a recovery accumulator-feeder for the second liquid, which has been kept at a high temperature in an accumulator.

The second liquid contains some dissolved solids, since it was used in the previous boiling as a final wash, or third liquid. After appropriate soaking time with the chips, the second liquid is moved into the empty first accumulator. The third liquid is then transferred to the second accumulator. As such, the chips are exposed to three hot liquids in the process, each one containing less and less solid material. The first liquid acts largely as a boiler while the second and third are used primarily to reduce the dissolved solid content of the boiled chips.

Following the transfer of the final third liquid to the second accumulator, the extractor is emptied to a low-blowing condensor, and the condensed vapours are returned to the alcohol tanks, completely recovered and reusable in the process.

Finally, the boiled chips are stripped with steam to remove and recover residual alcohol, and the pulp is unloaded from the extractor. The pulp is then filtered and cleaned in the conventional way, thinned, and sent for whitening. A washing machine for unwhitened pulp isn't needed. The complete process can take from 5 to more than 7 hours, depending on the design conditions.

The first liquid, which ultimately becomes the black liquid—loaded with solids—is run through an exchange in a low-blowing condensor at atmospheric pressure, and from there the vapours go to an accumulation tank of alcohol recovered from liquids rich in solids, it goes through a sequence of purification where the lignin is recovered, this is then dried and packed. The remaining liquid is then taken to a distillation tower where the leftover alcohol is recovered, the furfural is extracted, the residue is evaporated to be burnt or to obtain additional by-products.

Pilot studies have shown that the Alcell pulping process may be used according to the present invention and has the following advantages:—
Has greater yields than the Kraft process
Can be used with the same ease in absorbent and print paper
Is easy to bleach—without the need to use chlorine
Can be bleached at 90% ISO (International Standards Organization) and it produces pulps more resistant than the sulphite and the TMP (thermomechanical pulp) is comparable to pulps produced by the Kraft process.
Due to the ease of recovery of reagents and the reduced need to use control equipment, it allows smaller scale production than the Kraft process.
The quality of the pulp is comparable to conventional pulps
The production costs are lower than using the Kraft process
The process isolates the lignin in a relatively pure form.

### 8. NACO Process

This process uses NaCO₃, Oxygen and NaOH in a digester called a Turbo pulper. The de-lignification occurs through the oxygen reaction in a NaCO₃ solution with NaOH, acting as a catalyst and chemical transformer. The Turbo Pulper has an adjustment of perforated plate and rotor in the base that distinguishes the boil fibre at its end. Generally, two turbo pulpers are used in series, operating under a pressure of 6-7 bar under a consistency of 8%.

Because oxygen is the de-lignifying agent, the produced pulp has a high brightness percentage (50% ISO) it can be bleached easily in a peroxide stage to 80% ISO, or with ozone to 90% ISO.

The chemical recovery is similar to the chemical recovery of the soda water but it requires an energy source. The green liquid that is produced in the recovery plant has silica that is removed when the liquid is treated with lime. Caustification is not required because the system depends on NaCO₃, not on NaOH.

As mentioned above, the pulps produced according to the present invention (using any one of the above-mentioned methods or any other method) may be used in the manufacture of paper products such as, but not limited to, writing or printing paper, card, packaging etc.

In a further embodiment, defibrated material may be used to make agglomerate or composite boards, such as medium density fibreboard (MDF). MDF is defined by The Composite Panel Association as a dry panel manufactured using lignin-cellulose fibres derived from wood or some other fibrous material, that are mixed with a synthetic resin and/or other adhesive like lignin, and which are bonded under high temperature and pressure. The panel is typically compressed at a density of 500 to 800 kg/m³.

In contrast to particle boards, the density of MDF boards is more uniform with a smoother surface that eliminates the necessity for lamination or overlaying. Their extremes are compact and dense so they can be cut and worked.

According to an embodiment of the present invention, a fibreboard material (e.g. an agglomerate panel similar to MDF) may be manufactured using the following process. The fibreboard material may be made directly from the cellulose fibres of the plant in a process similar in some ways to the production of mechanical pulp produced from the fibres. In certain embodiments, the pith or marrow may optionally be eliminated. However, in the pulping process used to make agglomerate boards it is not necessary to produce a mechanical pulp like the ones described above, which may be used to make newspaper. It is enough to do a defibration using a pressurised steam digestor and a defibrating rotating discs as described above.

The process starts with the plant raw material, e.g. Arracacho pieces, which are softened in a pressurised steam digester, and de-fibred in a series of rotating discs like the ones that are used in a mechanic pulping process. After this, the fibres are taken to a dry place and mixed in operations that depend on the conglomerates that are to be used.

A pre-dryer may be used and the drying can be carried out in simple or multiple stages, usually two. To do the mixing, a blowing tube can be used injecting the conglomerate in a low-retention mixer. The most common resins are urea-formaldehyde, phenolics, melanins and isocyanates but all of them produce toxic emanations that need tight control. Accordingly in the present process the use of lignin is an appealing option. Between the drying and mixing stages, removing cyclones and fibre recovery devices are used before the product is sent to storage.

After this, the fibres are transferred to a formation machine where they are deposited on a continuous movement net which run through a pre-press and then to a hot press which can be done continually or in batches after a previous cut. The plates of the press are heated using vapour or hot oil. Finally the panels are allowed to cool, they are polished, cut in exact dimensions and are packed to be transported.

This process has been tested for use in the fabrication of other kind of panels using the stalk of the crushed Arracacho, pre-pressed, to be used to make boards. When this is being transported the conglomerate (perhaps lignin or a mixture of synthetic resins) is added. It is put through a pre-press to be shaped, and then through a high pressure and temperature press.

Although the invention has been described above with respect to the specific embodiments mentioned, a skilled person will appreciate that many alternative embodiments are possible within the scope of the appended claims.

1. A process for the production of a paper pulp, comprising preparing the pulp from a raw material derived from a plant of the Araceae family.

2. A process according to claim 1, wherein the plant is from the genus Montrichardia.

3. A process according to claim 2, wherein the plant is the species Montrichardia arborescens.

4. A process according to any preceding claim, comprising a step of treating the plant material with sodium hydroxide.

5. A process according to claim 5, wherein the concentration of NaOH in the treatment step is 11 to 13.5% by weight.

6. A process according to any preceding claim, wherein the maximum temperature used in the pulping process is 160 to 170° C.

7. A process according to any preceding claim, wherein the pulp is maintained at an elevated temperature for 10 to 30 minutes.

8. A process according to any preceding claim, which is a Kraft process, a soda process, an alkaline pulp process optionally using an anthraquinone catalyst, a granit wet oxidation process, a milox process using formic acid and hydrogen peroxide, a chempolis process, an alcell process, or a NaCO process.

9. A process according to any preceding claim, comprising a step of recovering lignin from the pulp.

10. A method according to any preceding claim, wherein the raw material comprises a stalk of a plant of the Araceae family.

11. A paper pulp obtainable by a process of any preceding claim.

12. A process for the production of paper, comprising preparing a paper pulp according to any of claims 1 to 10, and producing paper from the paper pulp.

13. A paper product obtainable by a method as defined in claim 12.

14. A process for the production of lignin, comprising preparing the lignin from a raw material derived from a plant of the Araceae family.

15. A process for the production of a fibreboard material, comprising preparing the fibreboard from a raw material derived from a plant of the Araceae family.

16. A paper pulp comprising an aqueous suspension of plant fibres, wherein the fibres have a mean length of 1.5 to 2.1 mm and a mean diameter of 26 to 36 μm.

17. A paper pulp according to claim 16, wherein the fibres have a mean length of 1.7 to 1.9 mm.

18. A paper pulp according to claim 16 or claim 17, wherein the fibres have a mean diameter of 29 to 33 μm.

19. A paper pulp according to any of claims 16 to 18, wherein the fibres have a mean wall thickness of 5.3 to 7.3 mm.

20. A paper pulp according to claim 19, wherein the fibres have a wall thickness of 5.8 to 6.8 mm.

21. A paper pulp according to any of claims 16 to 20, wherein the fibres are derived from a plant of the Araceae family.

22. A paper pulp comprising an aqueous suspension of fibres derived from a plant of the Araceae family.

23. A paper product or fibreboard comprising plant fibres having a mean length of 1.5 to 2.1 mm and a mean diameter of 26 to 36 μm.

24. A paper product or fibreboard comprising cellulose fibres derived from a plant of the Araceae family.

25. Use of a plant of the Araceae family for the production of paper pulp, paper products, lignin or fibreboard.
